(19) United States
(12) Patent Application Publication
(10) Pub. No.: US 2017/0088349 A1
(43) Pub. Date: Mar. 30, 2017

(54) Nested Drawstring Trash Bags

(71) Applicants: Jaiminkumar Rajubhai Patel, Boston, MA (US); Antonio Carlos Gomes Rocha, Meireles Fortaleza (BR)

(72) Inventors: Jaiminkumar Rajubhai Patel, Boston, MA (US); Antonio Carlos Gomes Rocha, Meireles Fortaleza (BR)

(21) Appl. No.: 15/263,444

(22) Filed: Sep. 13, 2016

Related U.S. Application Data
(60) Provisional application No. 62/234,923, filed on Sep. 30, 2015.
(60) Provisional application No. 62/322,889, filed on Apr. 15, 2016.

(51) Int. Cl. B65F 1/06; B31B 27/00; B65D 33/00; B65D 33/28; B65F 1/14

(52) U.S. Cl. CPC B65F 1/062; B65D 33/28; B65F 1/14; B65D 33/004; B65D 33/002; B31B 27/00; B65F 2220/12; B65F 2220/128; B31B 2219/9025; B31B 2221/50

(57) ABSTRACT

A nested trash bag apparatus for creating a set of nested bags in a way where a set of inner bags is placed within an outer bag and when an inner bag is detached from the set, another inner bag is already in place and ready to use within a waste basket.

### CROSS REFERENCE TO RELATED APPLICATIONS

This application takes priority from and claims the benefit of U.S. Provisional Patent Application Ser. No. 62/234,923 filed on Sep. 30, 2015 and U.S. Provisional Patent Application Ser. No. 62/322,889 filed on Apr. 15, 2016.

### FIELD OF THE INVENTION

The present invention relates generally to trash bags and more particularly to nested drawstring trash bags for creating a set of nested trash bags, wherein when an inner bag is detached from a refill bag, the next bag is already in place and ready to be used.

### BACKGROUND OF THE INVENTION

It is a frequent occurrence for individuals to line waste baskets, garbage containers, compost receptacles, and like containers with some type of bag device, like a plastic bag, so that when the user wishes to dispose of the contents within the receptacle, they simply can lift the bag out of the basket. These garbage bags are placed with the trash container for convenient collection of garbage.

Waste bins usually utilize a single layer disposable bag function. Typically, upon removing the filled trash bag, one must then reload the trash bin with a new plastic bag. Thus, every time an individual empties the waste bin and throws away the plastic garbage bag, he must then refill the waste bin and this process must be repeated again every time the waste bin is empty. This process may become tedious especially if there are several waste bins in one area that need to be constantly replaced, i.e. an office space. It can be burdensome to repeatedly replace the plastic bags in the bins because it may take a lot of time and energy to collect the bags and replace with new bags every day.

### SUMMARY OF THE INVENTION

The instant series of system, method and series of apparatuses, as illustrated herein, are clearly not anticipated, rendered obvious, or even present in any of the prior art mechanisms, either alone or in any combination thereof. Thus, the several embodiments of the instant system are illustrated herein.

In one aspect, the present apparatus introduces a nested drawstring trash bag, wherein the nested bags comprise one outer bag per refill, as well as more than one inner bags. In another aspect, the present apparatus introduces a set of nested drawstring trash bags.

In yet another aspect, the present apparatus introduces a nested drawstring trash bag to eliminate the need to place a new plastic bag in a waste bin repeatedly. Further, the present apparatus introduces a nested drawstring trash bag that provides more sanitary garbage removal. The present apparatus introduced a nested drawstring trash bag that eliminates the need to clean a trash bucket or bin if a first bag leaks. Thus, eliminating the spread of garbage contents and bacteria within the waste bin. Herein, when an inner bag is removed the next one is already in place within the trash bin.

An object of the current apparatus is to provide a nested drawstring trash bag for creating a set of nested drawstring trash bags in a way that one bag is inside the other composing a refill, thus when the inner bag is detached from the refill, the next bag is already in place and ready to be used within the trash bin.

A further object of the current apparatus is to provide a nested drawstring bag that assists in more efficient garbage removal, as well as, saving the user/consumer time.

Realizing one aspect of the apparatus is a set of nested drawstring bags that provide efficient, easy, sterile, and convenient garbage removal, wherein when an inner bag is detached from the perforated line of an outer bag and removed from a trash bin or similar container, the next bag is already in place within the trash bin and ready to be used.

These together with other objects of the system and apparatus, along with the various features of novelty, which characterize the system and apparatus, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 illustrates a front view of the present apparatus, wherein cross section line A-A is shown and further illustrated in FIG. 2;

FIG. 2 illustrates an exploded side view of the present apparatus, wherein cross section line A-A is shown and wherein circled section B is shown and further illustrated in FIG. 3;

FIG. 3 illustrates a zoomed in view of the present apparatus, specifically showing the further details of circled section B from FIG. 2;

FIG. 4 illustrates a front view of the present apparatus, wherein cross section line C-C is shown and further illustrated in FIG. 5;

FIG. 5 illustrates an exploded side view of the present apparatus, wherein cross section line C-C is shown and wherein circled section D is shown and further illustrated in FIG. 6;

FIG. 6 illustrates a zoomed in view of the present apparatus, specifically showing the further details of circled section D from FIG. 5;

FIG. 7 illustrates a perspective view of an additional embodiment of the present apparatus;

FIG. 8 illustrates a perspective view of a further additional embodiment of the present apparatus;

FIG. 9 illustrates a front view of the present apparatus, wherein cross section line E-E is shown and further illustrated in FIG. 10;

FIG. 10 illustrates an exploded side view of the present apparatus, wherein cross section line E-E is shown and wherein circled section F is shown and further illustrated in FIG. 11;

FIG. 11 illustrates a zoomed in view of the present apparatus, specifically showing the further details of circled section F from FIG. 10;

FIG. 12 illustrates a front view of an additional embodiment of the present apparatus, wherein cross section line G-G is shown and further illustrated in FIG. 13;

FIG. 13 illustrates an exploded side view of an alternative embodiment of the present apparatus, wherein cross section line G-G is shown and wherein circled section H is shown and further illustrated in FIG. 14; and,

FIG. 14 illustrates a zoomed in view of an alternative embodiment of the present apparatus, specifically showing the further details of circled section H from FIG. 13.

### DETAILED DESCRIPTION OF THE SEVERAL EMBODIMENTS

For the following defined terms these definitions shall apply, unless a different definition is given in the claims or elsewhere in this specification. All numeric values are herein assumed to be modified by the term “about”, whether or not explicitly indicated. The term “about” generally refers to a range of numbers that one of skill in the art would consider equivalent to the recited value (i.e., having the same function or result). In many instances, the terms “about” may include numbers that are rounded to the nearest significant figure.

As user in this specification and the appended claims, the singular forms “a”, “an”, and “the” include plural referents unless the content clearly dictates otherwise. As used in this specification and appended claims, the term “or” is generally employed in its sense including “and/or” unless the content clearly dictates otherwise.

The following description should be read with reference to the drawings wherein like reference numerals indicate like elements throughout several views. The drawings, which are not necessarily to scale, depict illustrative embodiments of the claimed invention.

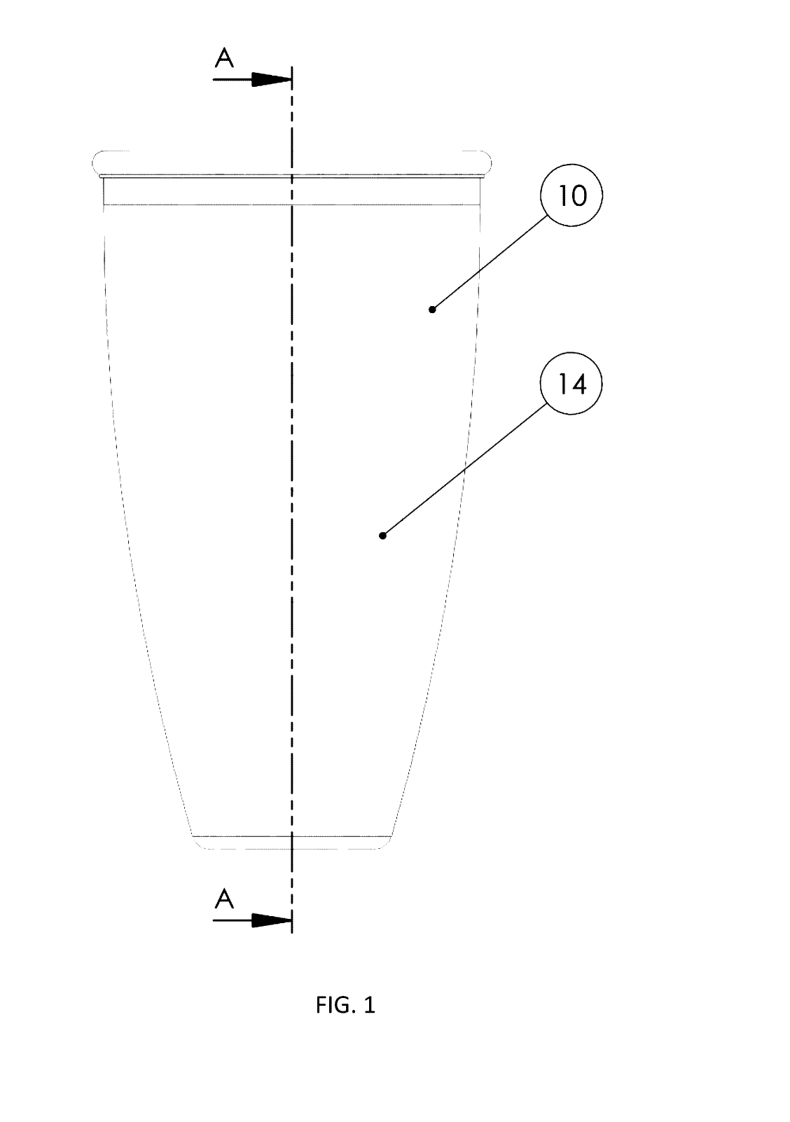

Turning now to the figures, FIG. 1 illustrates a front view of one embodiment of the present apparatus. Herein, outer bag 10 is shown. The apparatus set comprises one outer bag 10 and several inner bag refills. Like any typical bag structure, the outer bag and the inner bag refills comprise of an open top and a closed bottom. The outer bag 10 is longer than any inner bag 20 within the outer bag. The outer bag 10 may be comprised of a polymeric material, or other suitable material like an eco-friendly, bio-degradable material and/or recycled material. Further, the outer bag 10 may have a built-in attachment means or fastener like a retaining band or elastic band 13 in communication with the edge of the outer bag to assist in attaching the apparatus to a waste bin.

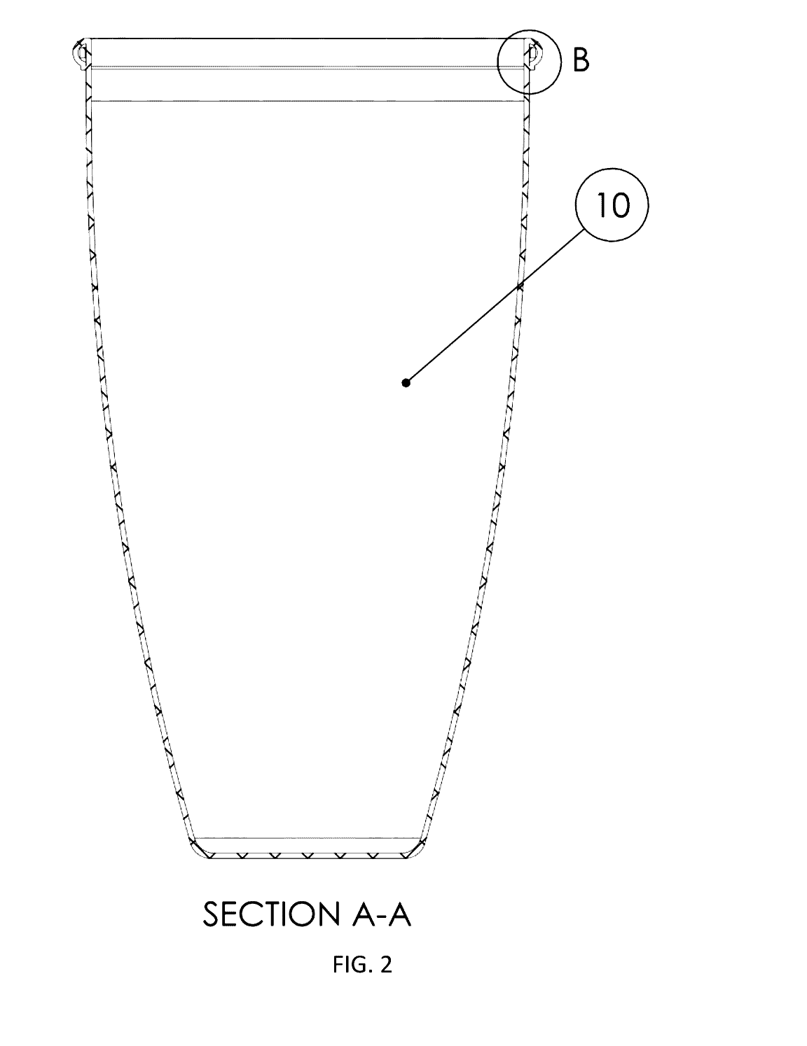

The outer bag 10 is the most external bag of the set of nested bags. FIG. 1 also shows one embodiment wherein a printed section 14 may be on the outside service of the outer bag 10. Cross-section line A-A represents a cross sectional view shown in FIG. 2 of the outer bag 10.

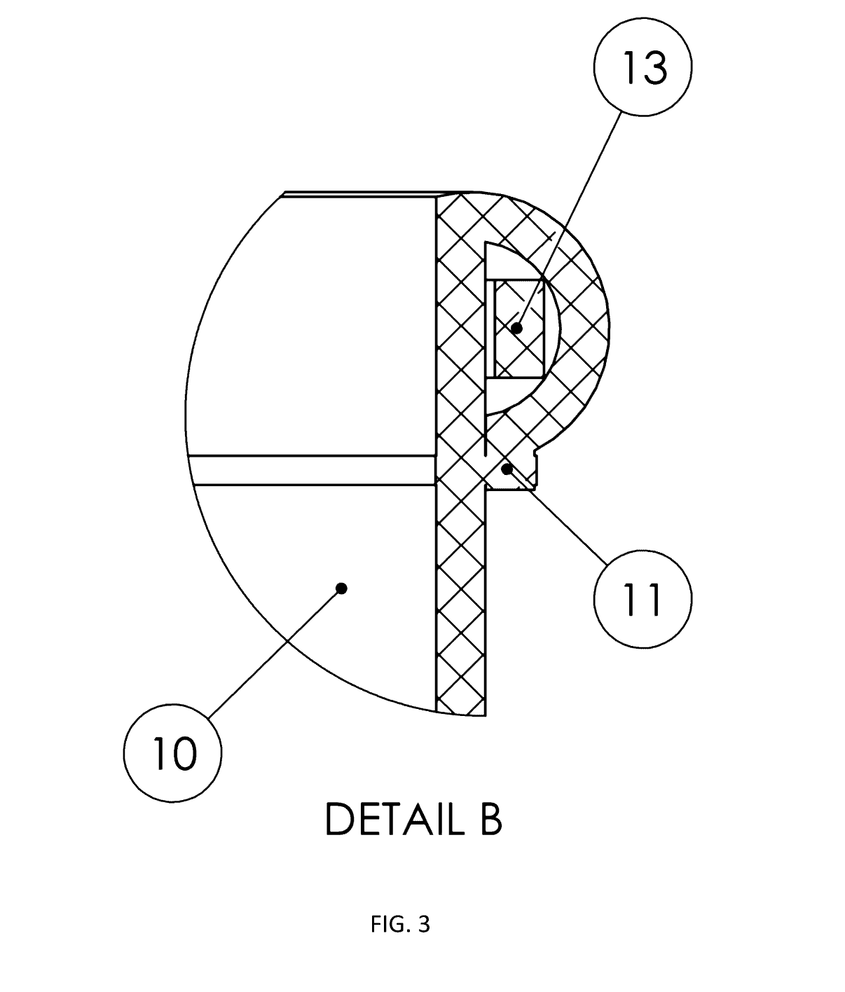

Turning to FIG. 2, which illustrates a cross section view of outer bag 10. From this perspective, one embodiment of the thickness of the bag is shown, as well as, circled section B, which reveals additional features of the outer bag 10, as seen in FIG. 3.

FIG. 3 illustrates a zoomed in view of the outer bag from circled section B of FIG. 2. Herein, the outer bag 10 further comprises a built-in retaining band mechanism 13 and a heated and sealed section part-1 11, which may create a loop on the edge of the outer bag 10. The heated and sealed section part-1 11 is constructed when a loop on the edge of the outer bag 10 is manufactured. Inside the loop, the retaining band 13 is inserted and housed. The outer bag 10 further provides support for the inner bags 20 and attaches the set of nested bags to any regular same sized waste cans or garbage bins, while still holding the set of nested bags in place when in use.

The apparatus may encompass additional features and embodiments without affecting the overall functionality of the outer bag 10. It should be noted that alternative dimensions of the size of the bags may be utilized, as well as changes in the thickness of the outer bag. In addition, outer bag 10 may be transparent to allow the consumer/user to see through it. Moreover, as indicated in FIG. 1, a printed section 14 may be printed on the outer bag 10.

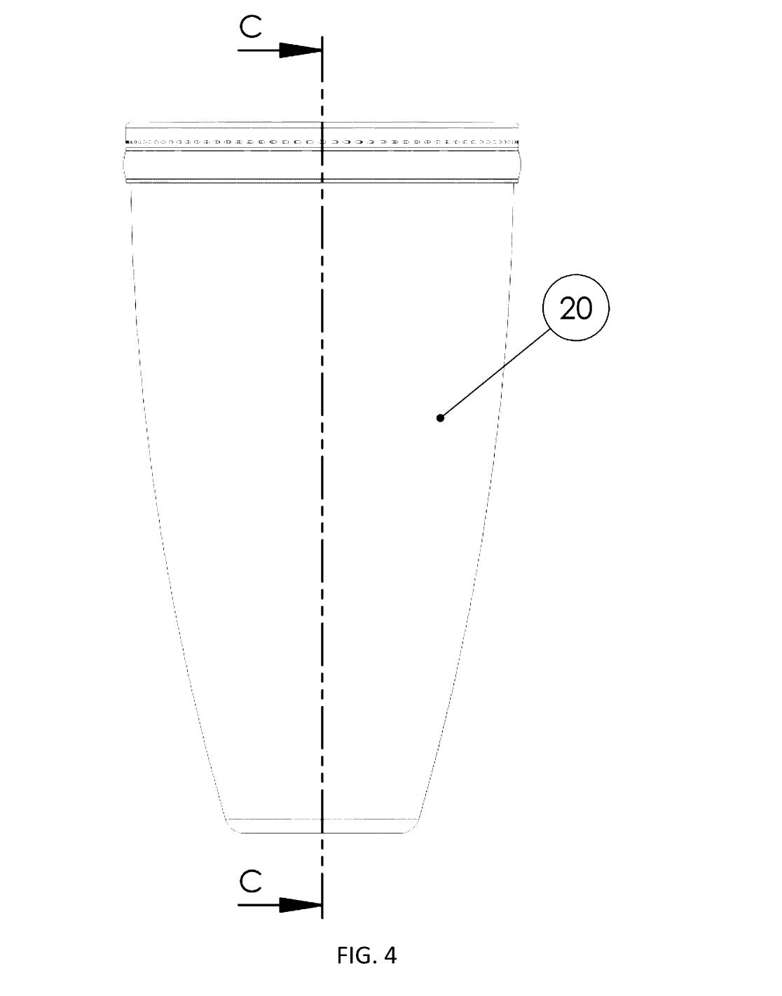

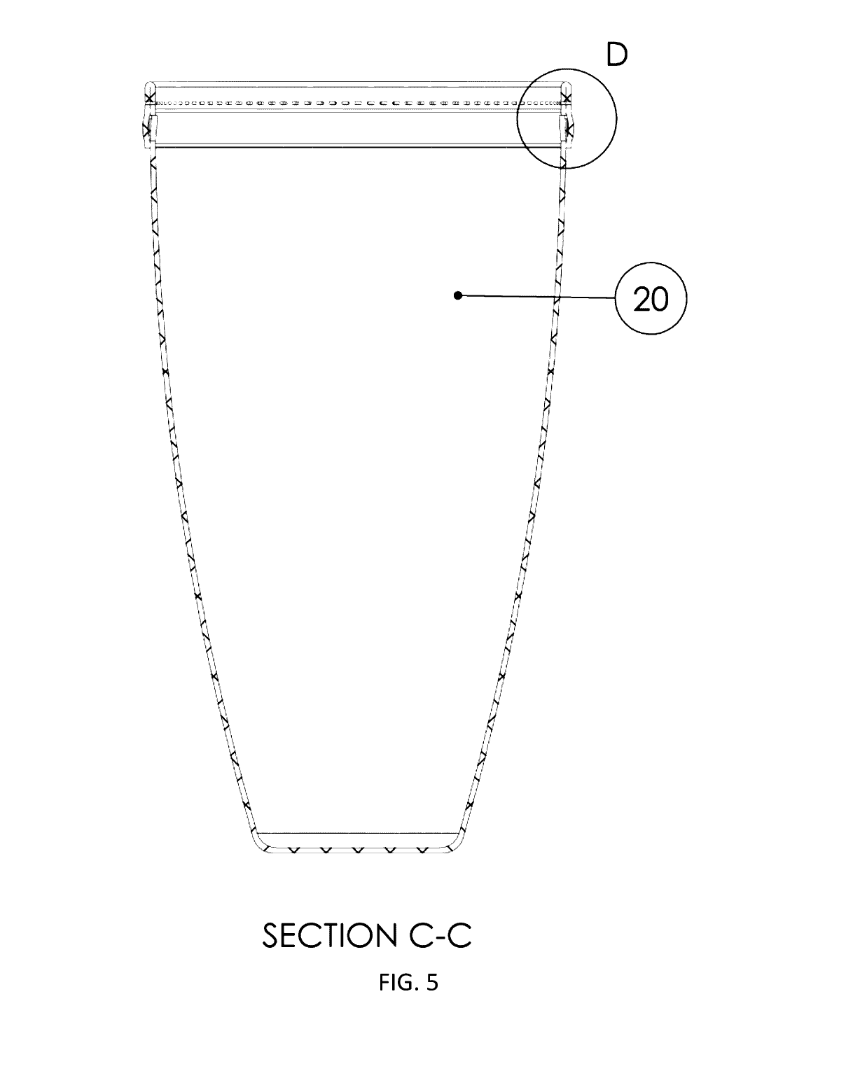

Turning now to FIG. 4 which illustrates a front view of the inner bag 20. In preferred embodiments, there are several inner bags 20 per set of nested bags. Similarly, to the outer bag, the inner bag may be comprised of a polymeric material, or other suitable material like an eco-friendly, bio-degradable material. Herein, line C-C indicates a cross-section of the inner bag that will be illustrated in FIG. 5.

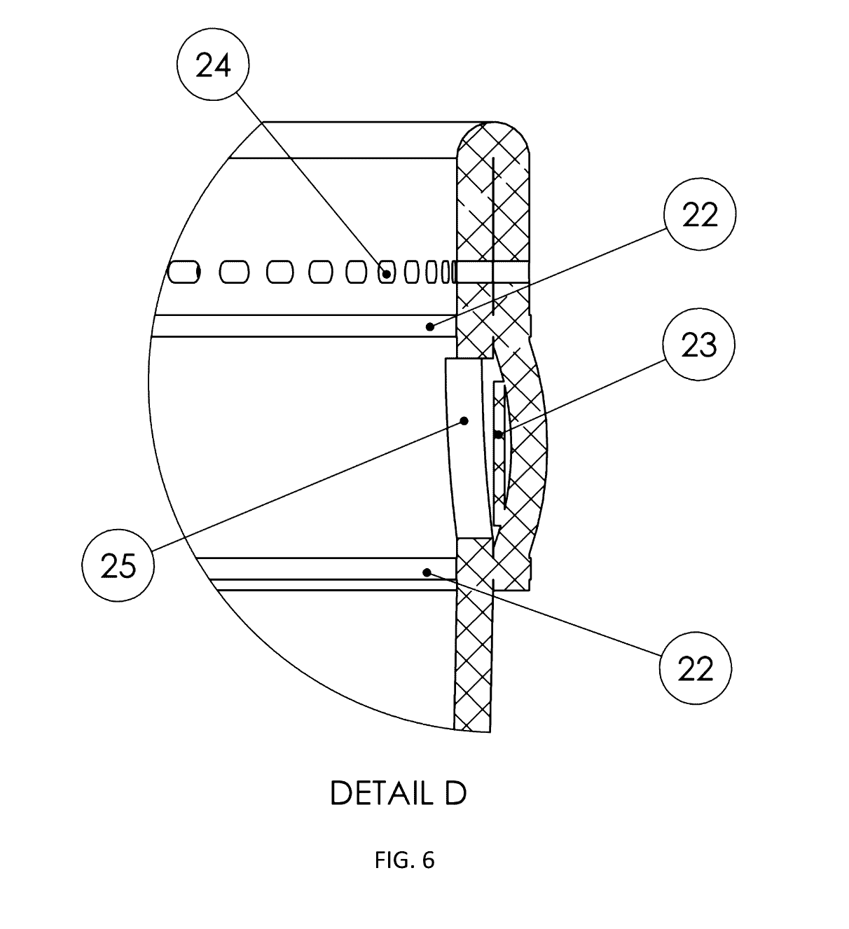

FIG. 5 illustrates an exploded side view of the inner bag 10. In preferred embodiments, there are several inner bags per set of nested bags. The inner bags 20 are housed within the outer bag 10. From this view, one embodiment of thickness of the inner bag is represented. Further, circled section D, reveals additional features of the inner bag 20, as seen in FIG. 6.

FIG. 6 illustrates a zoomed in view of the inner bag from circled section D of FIG. 5. Herein, a loop is created by folding the edge of the inner bag 20. A heated and sealed section part-3 22 is created in order to create the loop necessary to insert a drawstring strip mechanism 23. Herein, an opening window 25 creates an aperture on the inside of the inner bag 20 with the purposes of providing a user with finger access to the drawstring strip mechanism 23. In an additional embodiment, above the heated and sealed section part-3 22, the inner bag further comprises a set of perforated lines strip 24 that is circumferentially extended around the inner bag 20. Each inner bag comprises of a drawstring mechanism and a set of perforated lines strip that encompass the entirety of the inner bag. In alternate embodiments, the set of perforated lines may have different types of perforation.

In a preferred embodiment, the inner bags 20 are the most internal bags of the apparatus. Each inner bag comprises the drawstring strip mechanism 23 circumferentially extended from the open top of the inner bag and the set of perforated lines 24. The inner bags 20 are detached from each other when the drawstring strip mechanism 23 is pulled and the bag is separated by the perforated lines 24. Similar to the outer bag, the inner bag may have varying thickness, shape, size, spatial distribution, etc. depending on the embodiment represented.

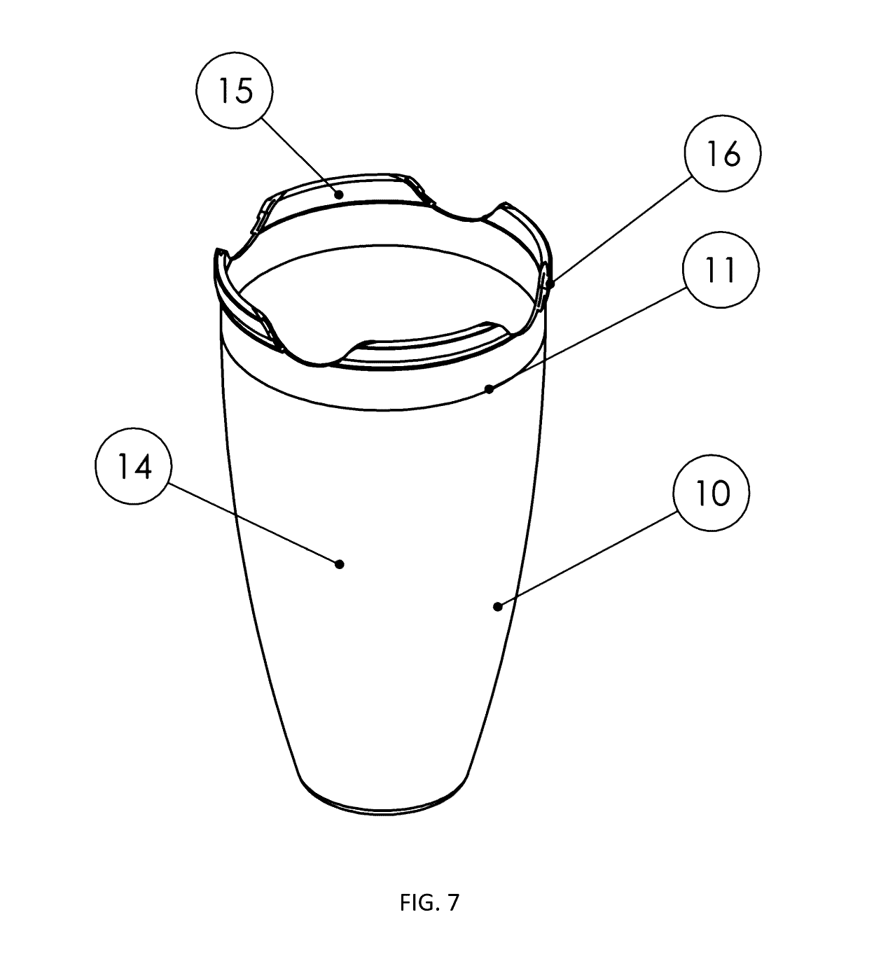

Turning now to FIG. 7, alternative embodiment of the outer bag 10 shown in a perspective view so that the printed section 14 is shown, as well as, the heated and sealed section part-1 11. Herein, the addition of outer tab mechanisms 15 are shown. These punched sections are near the edge of the outer bag 10 and are created by cutting circular shapes on the edge of the outer bag 10 may be comprised of a polymeric material, or other suitable material like an eco-friendly, bio-degradable material. The outer tab mechanisms 15 creates an easier installation of the set of nested bags to a waste bin or garbage can. An additional embodiment may also include adhesive material devices 16. The adhesive material devices 16 are placed on the outside surface of the outer bag 10. The adhesive materials 16 may be a possible substitute to the retaining band 13. With the adhesive material devices 16, the nested bag set may be placed around a can or bin, and the adhesive materials are attached to the can or bin to ensure the set of nested bags stay in a fixed position while the bags are used and until all the bags are used. In alternate embodiments, the adhesive materials 16 may be any type of an adhesive material, including glue and other similar means.

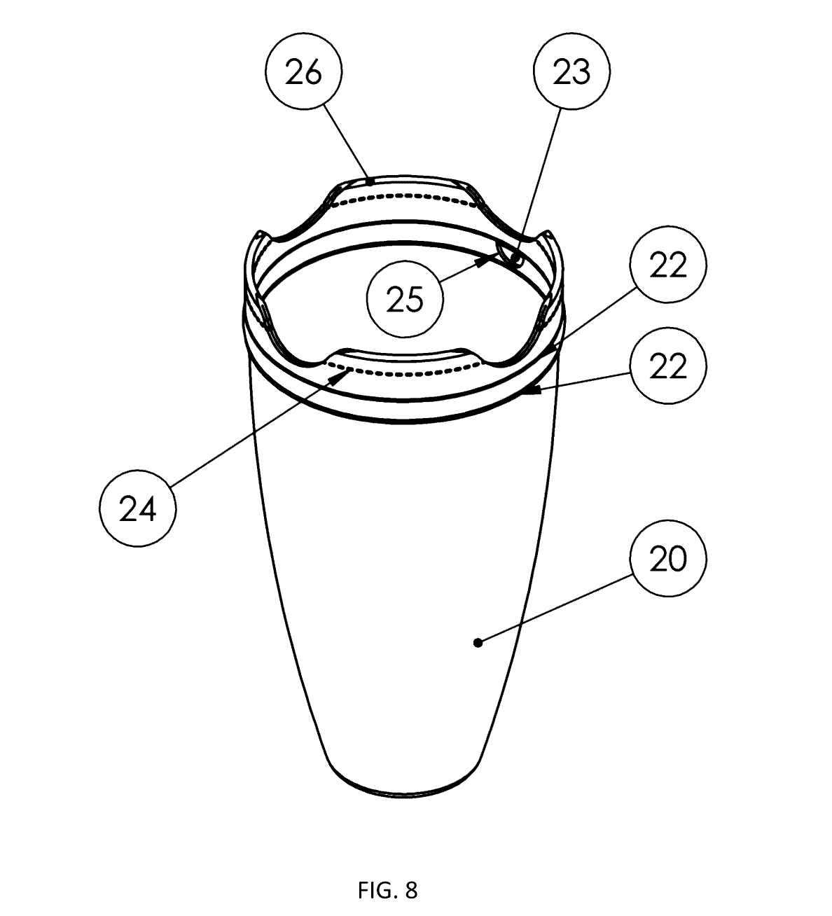

FIG. 8 illustrates an alternative embodiment of the inner bag 20 shown in a perspective view so that the inner bag 20, the perforated lines 24, the drawstring strip mechanism 23, the opening window 25, and the heated and sealed section part-3 22 are shown. Herein, in additional embodiments, the addition of inner tabs 26 are illustrated. Inner tabs 26 may be obtained by cutting a circular shape on the edge of the inner bag 20. These punched sections near the inner bag 20 edge may allow the process of wrapping the nested bag apparatus around a trash can or bin easier.

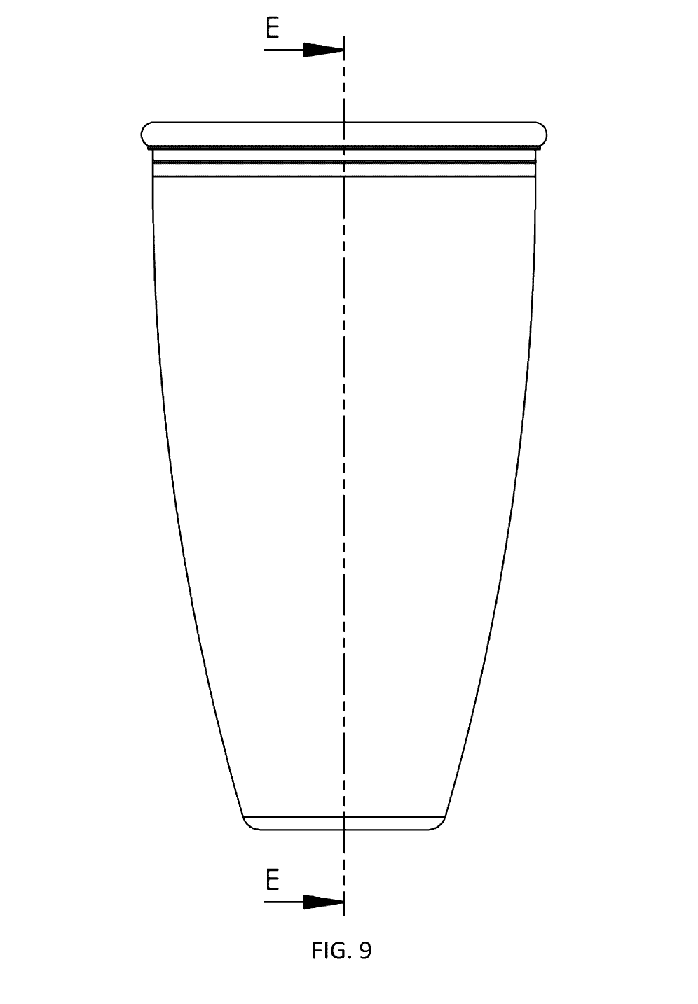

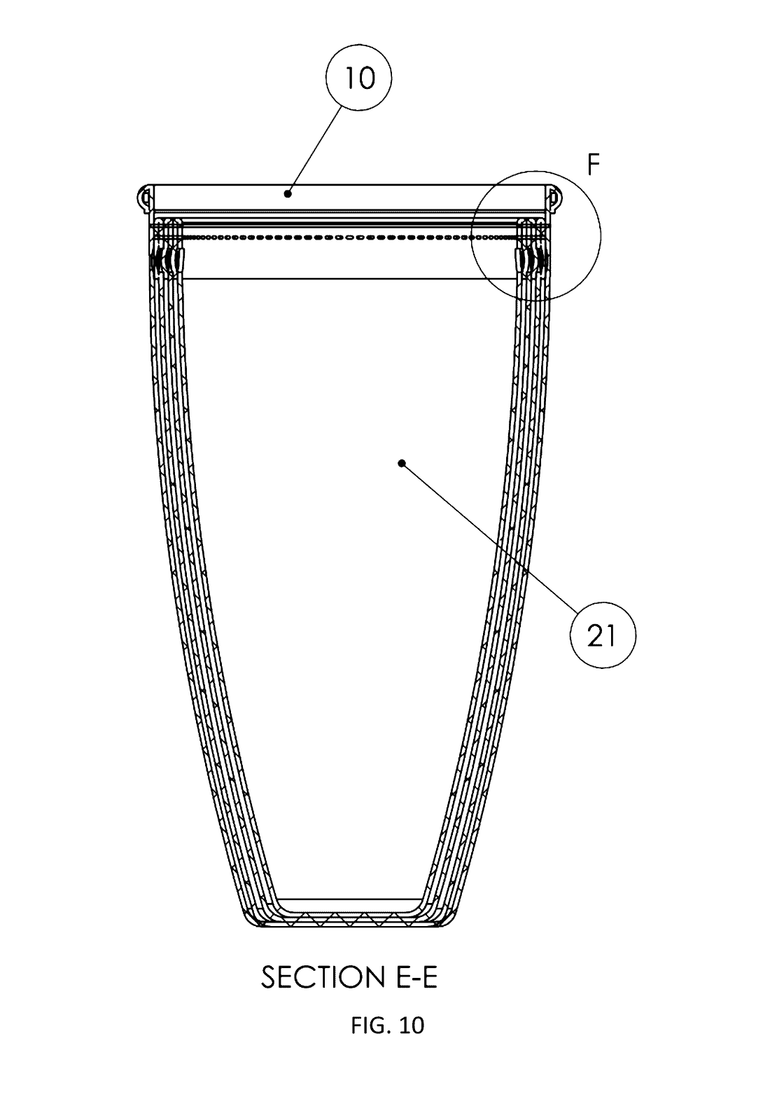

FIG. 9 illustrates a front view of the present apparatus of nested bags fully assembled. The view is also transparent so that the inner bags 20a, 20b, 20c are visible within the outer bag 10. Further, cross section line E-E represents a cross sectional view of the apparatus in FIG. 10.

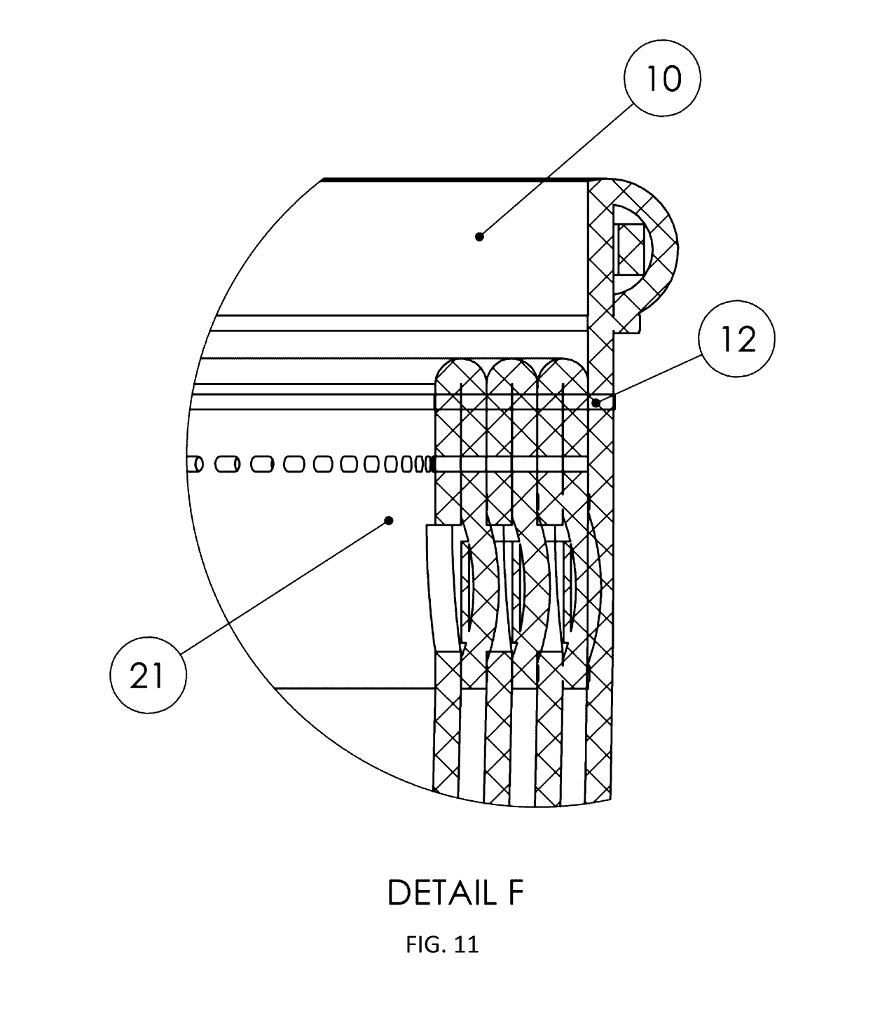

Turning to FIG. 10, which illustrates a cross section view of the apparatus of nested bags fully assembled. Herein, the outer bag 10 houses a set of inner bags 21. A set of inner bags 21 may comprise a series of inner bags 20. Herein, as shown in this FIG. 10, the set of inner bags 21 comprise inner bags 20a, 20b, and 20c. In further embodiments, the set of inner bags 21 may comprise a number of inner bags 20. Further, circled section F reveals additional features of the apparatus, as seen in FIG. 11.

FIG. 11 illustrates a zoomed in view of the apparatus of nested bags from circled section F of FIG. 10. Herein, the details of the fully assembled apparatus is illustrated. The set of inner bags 21 comprise a series of inner bags, 20a, 20b and 20c.

In one embodiment, the outer bag 10 and the set of inner bags 21 are in communication with one another by a series of heating and sealing processes. Herein, heat is applied to films of the plastic bags and the outer and inner bags are bonded together, creating a sealing section. Both the outer bag 10 and the set of inner bags 21 may be created by common plastic bag manufacturing processes in which a plastic film is folded in an automated production line, and then both the side and the bottom of the film are heated and sealed, leaving one open edge so that the bag can be used to store trash or any other object that may fit. As shown in FIG. 11, the heated and sealed section part-2 12 is responsible for ensuring that the outer bag 10 and the set of inner bags 21 are in communication with each other composing one set of nested trash bags.

In a further embodiment, the outer bag 10, the retaining band is loose inside the loop created by the heated and sealed section part-2 12. The inner bags 20, the drawstring strip mechanism 23 is heated and sealed at both sides where the bag itself is sealed. The loops of the inner bags 20 are created by heated and sealed section part-2 12. As a whole, the set of inner bags 21 and the outer bag 10 are also heated and sealed together in heated and sealed section part-1 11 as shown in FIG. 3.

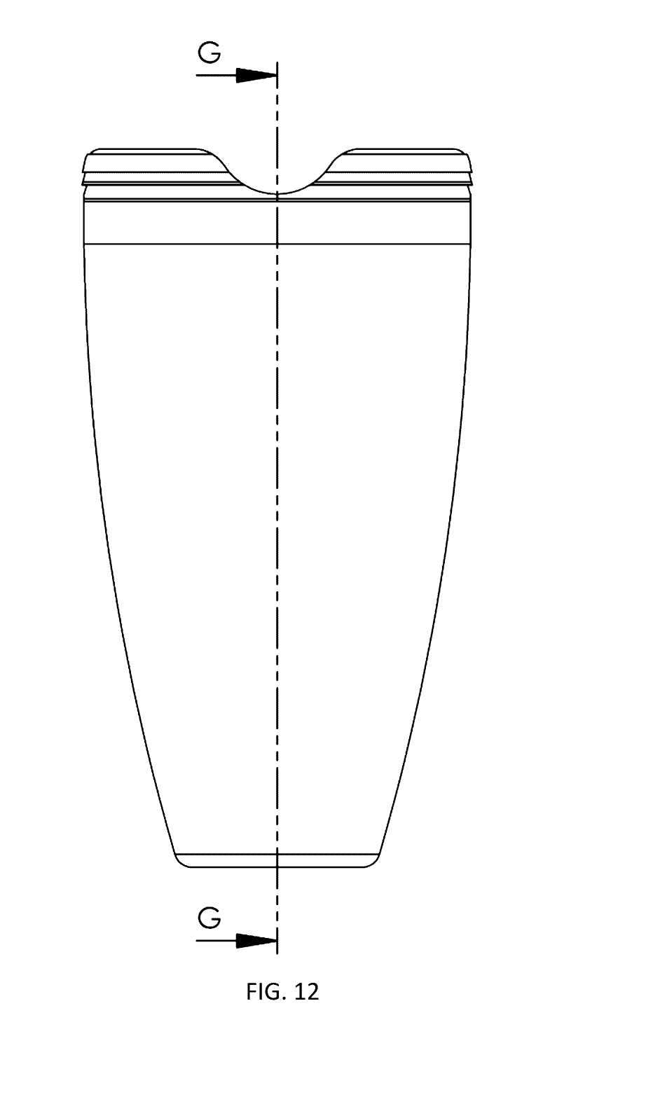

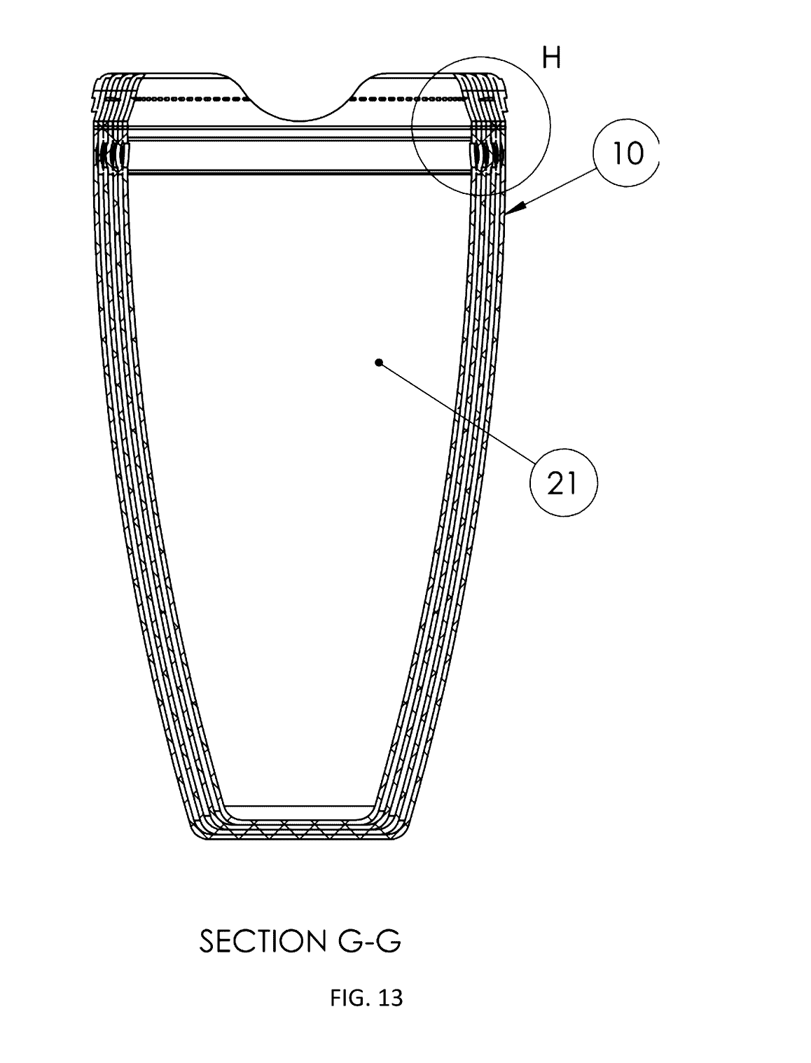

FIG. 12 illustrates a transparent front view of an alternative embodiment of the nested bags apparatus fully assembled. Herein, the transparent view illustrates the inner bags 20d, 20e, 20f within the outer bag 10. Further, cross section line G-G represents a cross sectional view of the apparatus in FIG. 13.

FIG. 13 illustrates a cross section view of an additional embodiment of the apparatus of nested bags fully assembled.

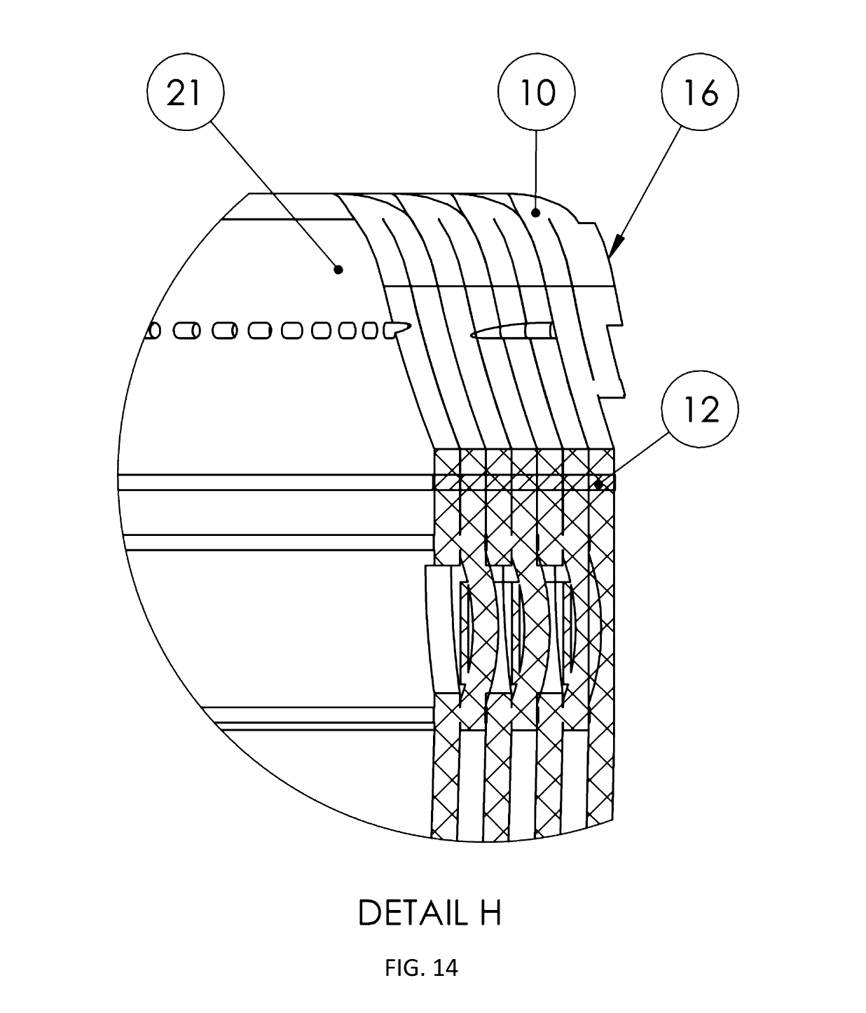

Herein, the outer bag 10 houses a set of inner bags 21. Herein, as shown, the set of inner bags 21 comprises inner bags 20d, 20e, and 20f. In further embodiments, the set of inner bags 21 may comprise a number of inner bags 20. Further, circled section H reveals additional features of the apparatus, as seen in FIG. 14.

FIG. 14 illustrates a zoomed in view of an additional embodiment of the apparatus of the nested bags from circled section H of FIG. 13. Herein, the details of the fully assembled apparatus is illustrated. The set of inner bags 21 comprise a series of inner bags, 20d, 20e and 20f. In one embodiment, the heated and sealed section part-2 12 is responsible for the communication of all the parts together, composing on single set of nested bags. Further, outer bag 10 comprises a adhesive material device 16 which is position on the outside surface of the outer bag 10 and allows for easy attachment to a trash can or garbage bin.

It should be understood that various alternatives to the embodiments of the disclosure described herein may be employed in practicing the disclosure. Elements of an implementation of the systems and methods described herein may be independently implemented or combined with other implementations. It is intended that the claims to follow with the utility application define the scope of the disclosure and that systems, methods, and devices within the scope of these claims and their equivalents be covered thereby.

Alternative embodiments may include changes in size of the outer and inner bags, as well as variation in transparency, color, design, and manufacturing processes.

Finally, operation of a preferred embodiment of the nested bag apparatus is outlined below. An apparatus of nested bags is placed and/or wrapped around a trash can or waste bin of any shape. The attachment means or retaining band 13 may be stretched around a lip of a trash can thus installing the apparatus of nested bags within the trash bin. When the retaining band surrounds the lip of the trash bin it ensures that the nested bags are stably in positioned and strongly in communication with the trash can, preventing the bags from moving around when in use. As explained above, the attachment means or retaining band 13 is built-in to the outer bag 10. Once the nested bag apparatus is installed within a trash bin, the bags are ready to receive contents like trash, waste, or other kinds of objects.

When an inner bag 20 is filled and needs to be removed from the trash bin, 3 the user has to reach the drawstring strip mechanism 23 from both opening windows 25 of the inner bag being used, activate and pull them. When bringing each side of the drawstring strip mechanism 23 close to each other, or when tying the bag using the drawstring strip 23, force of the user will naturally be applied inwards to the bags. This user's force is enough to detach the inner bag 20 from the rest of the refill, because it is torn apart from the perforated lines 24. This process leaves behind, sealed in the refill, the top part of the inner bag 20, that is, the piece of plastic right above the perforated line 24 is kept attached to the refill inside the can or bin. The remaining bag that is left in the bin is now ready for trash disposal.

This process may be repeated as many times as the number of inner bags 20 is in the refill. When it comes the time the user is left with only the outer bag 10, the procedure is slightly varied. The user just needs to stretch the retaining band 13 over the lip of the trash bin and remove the outer bag 10 sealed together with the remaining top parts of all already used inner bags 20. Now, the outer bag is ready to be discarded, the nested bag apparatus has been used in its entirety and the user must install an additional nested bag apparatus.

In an additional embodiment, the nested bag apparatus may be constructed to notify the user when he is almost out of inner bags and might need to replace the nested bag apparatus. As mentioned previously, there is only one outer bag 10 in the refill, which may be made out of a white plastic material with some degree of transparency. Therefore, when holding the outer bag 10 in the user's hands, the user is able to see the optional printed section 14 from the outside and from the inside of the bag. All the inner bags 20 in the set may also be made out of white plastic with some degree of transparency. That means, when the user put one inner bag 20 inside of another, the refill becomes less transparent, that is, step by step the refill comes closer to a solid color and the user can no longer see through the bags. Thus, when the apparatus of nested bags is fully loaded, the color seems solid white and as the user removes inner bags and the color becomes more transparent, the user will be alerted that it may be time to replace the nested bag apparatus.

What is claimed:

1. A nested trash bag apparatus comprising:
a set of nested bags comprising:
an outer bag;
at least one inner bag, wherein both the outer bag and the at least one inner bag comprises an open top and a closed bottom;
wherein the at least one inner bag is nested within the outer bag in a nested configuration and the at least one inner bag is detachably in communication with the outer bag such that upon extraction of the at least one inner bag from the set of nested bags, a second inner bag is automatically available for use;
a drawstring strip mechanism circumferentially extended from the open top of the at least one inner bag;
a perforated lines strip circumferentially extended from the open top of the at least one inner bag;
at least one fastener mechanism for attaching the set of nested bags to a waste container;
wherein the at least one inner bag is separated from the outer bag by pulling the drawstring strip mechanism and tearing the at least one inner bag along the perforated lines strip to remove the at least one inner bag and dispense a further inner bag within the outer bag.

2. The nested trash bag apparatus of claim 1, wherein the outer bag and the at least one inner bag are made of a material selected from the group consisting of: polymeric material, eco-friendly, bio-degradable material and recycled material.

3. The nested trash bag apparatus of claim 1, wherein the outer bag is a most external bag of the set of nested bags.

4. The nested trash bag apparatus of claim 1, wherein the at least one inner bag further comprises plurality of inner bags.

5. The nested trash bag apparatus of claim 4, wherein the plurality of inner bags are a most internal bag of the set of nested bags.

6. The nested trash bag apparatus of claim 1, wherein the at least one fastener mechanism for attaching the set of nested bags to the waste container comprises a retaining band.

7. The nested trash bag apparatus of claim 3, wherein the retaining band is in communication with the open top of the outer bag.

8. The nested trash bag apparatus of claim 1, wherein the at least one fastener mechanism for attaching the set of nested bags to the waste container comprises an adhesive material device.

9. The nested trash bag apparatus of claim 1, wherein the nested configuration is produced by a prepackaged manufacturing process.

10. The nested trash bag apparatus of claim 9, wherein the prepackaged manufacturing process comprises of a heating and a sealing process, wherein heat is applied to the outer bag and the at least one inner bag to attach the at least one inner bag to the outer bag.

11. The nested trash bag apparatus of claim 1, wherein the outer bag further comprises a printed section.

12. The nested trash bag apparatus of claim 1, wherein the outer bag further comprises of a transparent material, wherein the at least one inner bag is visible from the outer bag.

13. The nested trash bag apparatus of claim 1, wherein the at least one inner bag further comprises of transparent material.

14. A method for manufacturing a set of nested bags of claim 1, comprising the steps of:
inserting at least one inner bag into an outer bag, wherein the at least one inner bags comprises a plurality of inner bags in communication in a nested configuration that upon extraction of the at least one inner bag from the set of nested bags, a bag of the plurality of inner bags is automatically available for use;
heating and sealing the outer bag to create a first loop on an edge of the outer bag;
inserting into the first loop on the edge of the outer bag a fastening mechanism;
heating and sealing the at least one inner bag to create a second loop on an edge of the at least one inner bag;
inserting into the second loop a drawstring strip mechanism; and,
heating and sealing the at least one inner bag to the outer bag to compose the set of nested bags.
